(19) United States
(12) Patent Application Publication
(10) Pub. No.: US 2008/0254336 A1
(43) Pub. Date: Oct. 16, 2008

(54) Composite anode showing low performance loss with time

(75) Inventor: Emad El Batawi, Sunnyvale, CA (US)

Correspondence Address: FOLEY AND LARDNER LLP;SUITE 500, 3000 K STREET NW, WASHINGTON, DC, 20007, US

(73) Assignee: BLOOM ENERGY CORPORATION

(21) Appl. No.: 11/785,034

(22) Filed: Apr. 13, 2007

(51) Int. Cl. H01M 8/10; C21D 1/26

(52) U.S. Cl. 429/33; 148/516

(57) ABSTRACT

A solid oxide fuel cell includes cathode electrode, a solid oxide electrolyte, and an anode electrode including a first sublayer and a second sublayer. The first sublayer is located between the electrolyte and the second sublayer. The first sublayer is composed of a doped ceria and the second sublayer is composed of a nickel containing phase and a ceramic phase including a doped ceria and scandia stabilized zirconia, such as scandia ceria stabilized zirconia.

### BACKGROUND

The present invention is generally directed to fuel cell components, and to solid oxide fuel cell anode materials in particular.

Fuel cells are electrochemical devices which can convert energy stored in fuels to electrical energy with high efficiencies. Electrolyzer cells are electrochemical devices which can use electrical energy to reduce a given material, such as water, to generate a fuel, such as hydrogen. The fuel and electrolyzer cells may comprise reversible cells which operate in both fuel cell and electrolysis mode.

In a high temperature fuel cell system, such as a solid oxide fuel cell (SOFC) system, an oxidizing flow is passed through the cathode side of the fuel cell while a fuel flow is passed through the anode side of the fuel cell. The oxidizing flow is typically air, while the fuel flow can be a hydrocarbon fuel, such as methane, natural gas, propane, ethanol, or methanol. The fuel cell, operating at a typical temperature between 750° C. and 950° C., enables the transport of negatively charged oxygen ions from the cathode flow stream to the anode flow stream, where the ion combines with either free hydrogen or hydrogen in a hydrocarbon molecule to form water vapor and/or with carbon monoxide to form carbon dioxide. The excess electrons from the negatively charged ion are routed back to the cathode side of the fuel cell through an electrical circuit completed between anode and cathode, resulting in an electrical current flow through the circuit. A solid oxide reversible fuel cell (SORFC) system generates electrical energy and reactant product (i.e., oxidized fuel) from fuel and oxidizer in a fuel cell or discharge mode and generates the fuel and oxidant using electrical energy in an electrolysis or charge mode.

Anode electrodes operating under conditions of extreme fuel starvation are usually irreversibly damaged. Such starvation conditions are usually encountered in stacks where isolated repeat elements (i.e., specific fuel cells) obtain less fuel than their neighboring elements (i.e., the neighboring fuel cells). These elements witness effective fuel utilization in excess of 100%. Similar conditions may arise during system transitions or operating anomalies where the fuel supply to the cell does not correspond to the current drawn. Under these circumstances, the oxygen ion flux to the anode will oxidize the anode constituents. Nickel present at the three phase boundary of traditional anodes will instantaneously oxidize. The phase change from Ni metal to NiO is accompanied by a change in volume that causes mechanical damage at the anode/electrolyte interface. This mechanical damage is characterized by delamination of the electrode from the electrolyte which increases the area specific resistance of the cell and dramatically decreases the stack performance. To avoid oxidation of the nickel and mechanical damage of the electrode electrolyte interface, which leads to delamination, one prior art solution was to employ an all ceramic anode. While the ceramic anodes show better stability in starvation conditions, they are associated with high polarization losses.

### SUMMARY

One aspect of the present invention provides a solid oxide fuel cell (SOFC) comprising a cathode electrode, a solid oxide electrolyte, and an anode electrode including a first sublayer and a second sublayer. The first sublayer is located between the electrolyte and the second sublayer. The first sublayer is composed of a doped ceria and the second sublayer is composed of a nickel containing phase and a ceramic phase including a doped ceria and scandia stabilized zirconia, such as scandia ceria stabilized zirconia.

### BRIEF DESCRIPTION OF THE DRAWINGS

FIG. 1 illustrates a side cross-sectional view of a SOFC of the embodiments of the invention.

FIG. 2 illustrates a side cross sectional view of a SOFC stack of an embodiment of the invention.

FIGS. 3 and 6B are SEM micrographs of anode electrode sublayers of a SOFC according to specific examples of the invention. FIG. 6A is an SEM micrograph of a single layer anode electrode of a SOFC according to a comparative example.

FIGS. 4A-4E and 5 are graphs of performance of the fuel cells according to a specific example of the invention. FIGS. 4A and 5 are plots of cell voltage versus time. FIG. 4B is a plot of air exhaust temperature (left axis and middle line), cell current (right axis and lower line) and fuel utilization percent (right axis and upper line) versus time. FIG. 4C is a plot of steam to carbon ratio in the fuel inlet stream versus time. FIG. 4D is a plot of beginning voltage (upper line) and end voltage (lower line) for each of the ten tested cells according to the specific example of the invention. FIG. 4E is a plot of voltage degradation for each of the ten tested cells according to the specific example of the invention.

### DETAILED DESCRIPTION OF THE EMBODIMENTS

The embodiments of the invention provide composite, multilayer anode electrodes for solid oxide fuel cells, such as reversible SOFCs (i.e., SORFC) and non-reversible SOFCs, that exhibit a low performance loss, such as low degradation, as a function of time. In a preferred embodiment, the anode electrode comprises two sublayers, where the sublayer closest to the electrolyte is composed of a doped ceria, and the sublayer distal from the electrolyte comprises nickel, a doped ceria and a scandia stabilized zirconia (“SSZ”), such as a scandia ceria stabilized zirconia (“SCSZ”), which can also be referred to as scandium and cerium doped zirconia. The doped ceria may comprise a trivalent oxide doped ceria, for example, lanthanum oxide, samarium oxide (also known as samaria), gadolinium oxide (also known as gadolinia), praseodymium oxide or yttrium oxide (also known as yttria) doped ceria. The trivalent oxide may comprise 10 to 40 molar percent of the doped ceria. The trivalent oxide in the closest sublayer may be the same as or different from the trivalent oxide in the distal sublayer. In the examples below, samaria doped ceria (“SDC”) is used as the doped ceria in the closest sublayer and gadolinia doped ceria (“GDC”) is used as the doped ceria in the distal sublayer. However, it should be understood that the other doped ceria compositions described above may be used instead.

The anode participates in the oxidation of fuel at the three phase boundaries, and the transport of current to the current collectors by means of its good in-plane conductivity. The anode separates these functions by means of a two sublayer structure. The first SDC sublayer closest to the electrolyte catalyzes the oxidation of the fuel while the second Ni/GDC/SCSZ sublayer distal from the electrolyte helps transport current to the metallic current collector ribs of the adjacent interconnect. Furthermore, the chemical composition of the individual layers is tailored to increase lifetime and provide good redox tolerance under conditions of high fuel utilization.

The multilayer anode electrode exhibits lower degradation rates, improved survivability under system operating conditions, improved tolerance to system failures, such as fuel starvation, lower degradation sensitivity to exceedingly high fuel utilization than a single layer anode electrode, which leads to increased reliability and lifetime of stacks in SOFC systems.

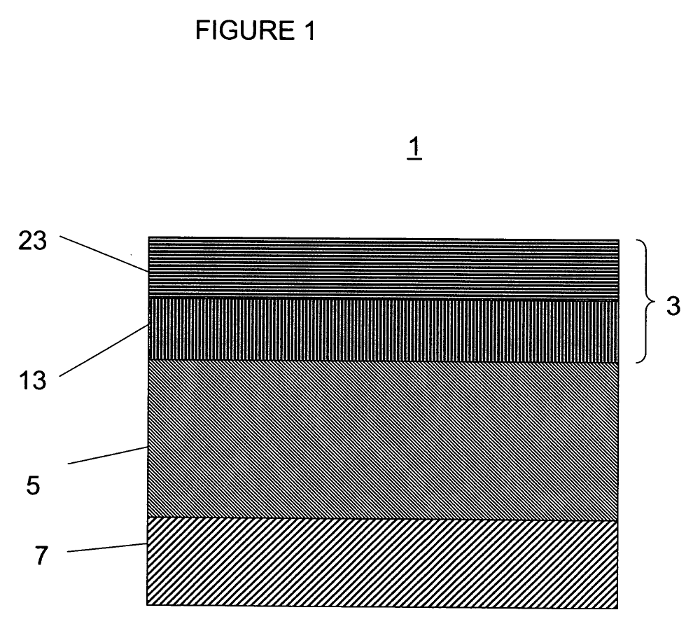

FIG. 1 illustrates a solid oxide fuel cell (SOFC) 1 according to an embodiment of the invention. The cell 1 includes an anode electrode 3, a solid oxide electrolyte 5 and a cathode electrode 7. The electrolyte 5 may comprise a stabilized zirconia, such as scandia stabilized zirconia (SSZ) (including scandia ceria stabilized zirconia (“SCSZ”)), and/or yttria stabilized zirconia (YSZ). For example, the electrolyte 5 may comprises a mixture of YSZ and one of SSZ or SCSZ, such as 3 to 10 molar percent YSZ/SCSZ mixture in an about 1:2 to about 1:4 weight ratio, such as an about 1:3 weight ratio. Alternatively, the electrolyte 5 may comprise another ionically conductive material, such as a doped ceria. Preferably, the electrolyte comprises SSZ or SCSZ having the following formula: [(ZrO₂)_{1-y}(CeO₂)_{y}]₁₋ₓ(Sc₂O₃)ₓ, where 0.06≦x≦0.11 and 0≦y≦0.01. While a stoichiometric stabilized zirconia is described by the formula, a non-stoichiometric stabilized zirconia may be used. For example, the electrolyte may comprise SCSZ having 1 molar percent ceria and 10 molar percent scandia (i.e., [(ZrO₂)_{1-y}(CeO₂)_{y}]₁₋ₓ(Sc₂O₃)ₓ, where x=0.1 and y=0.01). The electrolyte may also contain unavoidable impurities. Furthermore, the ceria in SCSZ may be substituted with alumina and/or yttria.

The cathode electrode 7 may comprise an electrically conductive material, such as an electrically conductive perovskite material, such as lanthanum strontium manganite (LSM). Other conductive perovskites, such as La₁₋ₓSrₓCoO₃, La₁₋ₓSrₓFe_{1-y}CO_{y}O₃ or La₁₋ₓSrₓMn_{1-y}CO_{y}O₃ where 0.1≦x≦0.4 and 0.02≦y≦0.4, respectively, may also be used. The cathode electrode 7 can also be composed of two sublayers (a SCSZ/LSM functional layer adjacent to the electrolyte and a LSM current collection layer over the functional layer).

As shown in FIG. 1, the anode electrode 3 comprises a first sublayer 13 and a second sublayer 23. The first sublayer 13 is located between the electrolyte 5 and the second sublayer 23. Preferably, the first sublayer 13 is located in contact with the electrolyte and the second sublayer 23 is located on the first sublayer 13. However, additional anode sublayers may be present below sublayer 13, between sublayers 13 and 23 and/or above sublayer 23.

The first sublayer 13 comprises a doped ceria, such as samaria doped ceria. The doped ceria preferably comprises 10 to 40 molar percent, such as 15 to 25 molar percent, such as for example 20 molar percent of the trivalent oxide, such as samaria, and a balance comprising ceria. The doped ceria may have the following formula: Ce_{1-z}A_{z}O_{2-δ}, where 0.1≦z≦0.4, preferably 0.15≦z≦0.25, and A is selected from one or more of La, Sm, Gd, Pr or Y. In other words, the ceria may be doped with one or more trivalent oxide. While a non-stoichiometric doped ceria is described by the formula where there is slightly less than two oxygen atoms for each metal atom, a doped ceria having two or more oxygen atoms for each metal atom may also be used. Preferably, the first sublayer contains no other materials, such as nickel, besides the doped ceria and unavoidable impurities. However, if desired, other materials may be added to sublayer 13, such as a small amount of nickel in an amount less than the amount of nickel in sublayer 23.

The second sublayer 23 comprises a cermet including a nickel containing phase and a ceramic phase. The nickel containing phase of sublayer 23 preferably consists entirely of nickel in a reduced state. This phase forms nickel oxide when it is in an oxidized state. Thus, when the anode is fabricated, the nickel containing phase comprises nickel oxide. The anode electrode is preferably annealed in a reducing atmosphere prior to operation to reduce the nickel oxide to nickel. The nickel containing phase may include other metals and/or nickel alloys in addition to pure nickel, such as nickel-copper or nickel-cobalt alloys (in a reduced state) and their oxides (in an oxidized state), for example Ni₁₋ₓCuₓO or Ni₁₋ₓCoₓO where 0.05≦x≦0.3. The nickel-copper or nickel-cobalt alloys may be used in internal reformation type SOFCs where a hydrocarbon fuel is reformed at the anode. The pure nickel (or pure nickel oxide) may be used for external reformation type SOFCs where a hydrocarbon fuel is reformed in an external reformer or for SOFCs which use hydrogen gas as fuel. The nickel is preferably finely distributed in the ceramic phase, with an average grain size less than 500 nanometers, such as 200 to 400 nanometers, to reduce the stresses induced when nickel converts to nickel oxide.

The ceramic phase of sublayer 23 preferably comprises a doped ceria and scandia stabilized zirconia. The ceramic phase may comprise a sintered mixture of the doped ceria and SSZ (containing some or no cerium) ceramic particles. The scandia stabilized zirconia may have the same composition as the scandia stabilized zirconia of the electrolyte 5. Preferably, the scandia stabilized zirconia of sublayer 23 has the following formula: [(ZrO₂)_{1-y}(CeO₂)_{y}]₁₋ₓ(Sc₂O₃)ₓ, where 0.06≦x≦0.11 and 0≦y≦0.01. While a stoichiometric stabilized zirconia is described by the formula, a non-stoichiometric stabilized zirconia may be used. For example, the electrolyte may comprise SCSZ having up to 1 molar percent ceria, about 6 to about 11 molar percent scandia and a balance comprising zirconia, such as SCSZ having 1 molar percent ceria and 10 molar percent scandia (i.e., [(ZrO₂)_{-y}(CeO₂)_{y}]₁₋ₓ(SC₂O₃)ₓ, where x=0.1 and y=0.01).

Any suitable doped ceria may be used in sublayer 23. For example, 10 to 40 molar percent trivalent oxide may be used. The doped ceria is preferably slightly non-stoichiometric with less than two oxygen atoms for each metal atom: Ce₁₋ₘDₘO_{2-δ} where 0.1≦m≦0.4 and D is selected from one or more of La, Sm, Gd, Pr or Y. In other words, the ceria may be doped with one or more trivalent oxide. It should be noted that element D may comprise the same or different element as A in the doped ceria in the first sublayer 13. However, a doped ceria containing two or more oxygen atoms for each metal atom may also be used. For example, the doped ceria may comprise GDC. The weight ratio of GDC to SSZ or SCSZ in sublayer 23 ranges from about 2:1 to about 5:1. For example, the weight ratio may be 5:1. If the ceramic phase contains no other components besides GDC and the stabilized zirconia, then the ceramic phase in sublayer 23 may range from about 70 (such as for example 66.66) weight percent GDC and about 30 (such as for example 33.33) weight percent stabilized zirconia to about 85 (such as for example 83.33) weight percent GDC and about 15 (such as for example 16.66) weight percent stabilized zirconia. The ceramic phase preferably contains no other ceramic materials besides GDC, one of SSZ or SCSZ and unavoidable impurities.

The second sublayer 23 preferably comprises 60 to 80 weight percent of the nickel containing phase and 40 to 20 weight percent of the ceramic phase, such as for example 75 weight percent of the nickel containing phase and 25 weight percent of the ceramic phase.

Any suitable layer thicknesses may be used. For example, the anode electrode 3 may be 20 to 40 microns thick, where the first sublayer 13 is about 5 to about 10 microns thick and the second sublayer 23 is about 15 to about 30 microns thick. The fuel cell is preferably a planar electrolyte supported cell in which the electrolyte is at least one order of magnitude thicker than the anode electrode. For example, the electrolyte 5 may be about 150 to about 300 microns thick. The cathode 7 may also be between 10 and 50 microns thick.

The sublayers 13 and/or 23 of anode 3 may contain a certain amount of porosity. The porosity in sublayer 23 may be greater than or less than the porosity in sublayer 13.

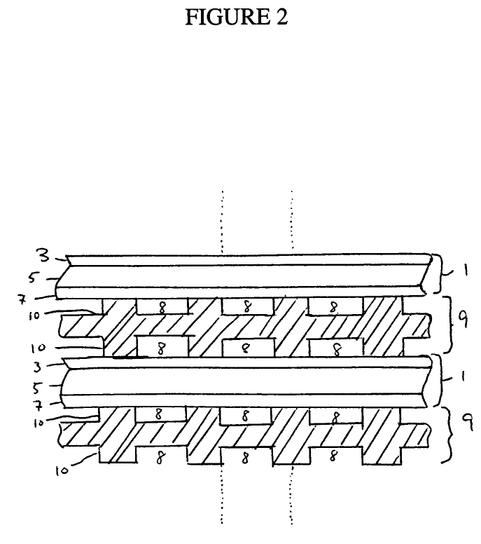

Fuel cell stacks are frequently built from a multiplicity of SOFC's 1 in the form of planar elements, tubes, or other geometries. Fuel and air has to be provided to the electrochemically active surface, which can be large. As shown in FIG. 2, one component of a fuel cell stack is the so called gas flow separator (referred to as a gas flow separator plate in a planar stack) 9 that separates the individual cells in the stack. The gas flow separator plate separates fuel flowing to the fuel electrode (i.e. anode 3) of one cell in the stack from oxidant, such as air, flowing to the air electrode (i.e. cathode 7) of an adjacent cell in the stack. The fuel may be a hydrocarbon fuel, such as natural gas for internally reforming cells, or a reformed hydrocarbon fuel comprising hydrogen, water vapor, carbon monoxide and unreformed hydrocarbon fuel for externally reforming cells. The separator 9 contains gas flow passages or channels 8 between the ribs 10. Frequently, the gas flow separator plate 9 is also used as an interconnect which electrically connects the fuel electrode 3 of one cell to the air electrode 7 of the adjacent cell. In this case, the gas flow separator plate which functions as an interconnect is made of or contains electrically conductive material, such as a Cr—Fe alloy. An electrically conductive contact layer, such as a nickel contact layer, may be provided between the anode electrode and the interconnect. FIG. 2 shows that the lower SOFC 1 is located between two gas separator plates 9.

Furthermore, while FIG. 2 shows that the stack comprises a plurality of planar or plate shaped fuel cells, the fuel cells may have other configurations, such as tubular. Still further, while vertically oriented stacks are shown in FIG. 2, the fuel cells may be stacked horizontally or in any other suitable direction between vertical and horizontal.

The term “fuel cell stack,” as used herein, means a plurality of stacked fuel cells which share a common fuel inlet and exhaust passages or risers. The “fuel cell stack,” as used herein, includes a distinct electrical entity which contains two end plates which are connected to power conditioning equipment and the power (i.e., electricity) output of the stack. Thus, in some configurations, the electrical power output from such a distinct electrical entity may be separately controlled from other stacks. The term “fuel cell stack” as used herein, also includes a part of the distinct electrical entity. For example, the stacks may share the same end plates. In this case, the stacks jointly comprise a distinct electrical entity. In this case, the electrical power output from both stacks cannot be separately controlled.

A method of forming a planar, electrolyte supported SOFC 1 shown in FIG. 1 includes forming the cathode electrode 7 on a first side of a planar solid oxide electrolyte 5 and forming the anode electrode 3 on a second side of the planar solid oxide electrolyte. The anode and the cathode may be formed in any order on the opposite sides of the electrolyte.

The anode electrode containing a plurality of sublayers shown in FIG. 1 may be formed by a screen printing method or by other suitable methods. For example, the first sublayer 13 can be screen printed on the electrolyte 5, followed by screen printing the second sublayer 23 on the first sublayer 13 using any suitable ceramic powder screen printing techniques. The screen printed cell is then sintered or fired at any suitable temperature, such as a temperature between 1150 and 1400° C. in air. The cell may be separately fired or sintered after the anode deposition and after the cathode deposition at the same or different temperature. The completed cell is preferably further annealed in a reducing atmosphere, such as a hydrogen or forming gas atmosphere, to covert nickel oxide to nickel in the anode prior to using fuel cell to generate electricity as part of a fuel cell system.

The anode electrode contains a doped ceria phase interface at a three phase boundary with the electrolyte and a nickel phase rich sublayer adjacent to the “free” surface of the anode electrode which is distal from the electrolyte (i.e., the surface of the anode 3 which faces the interconnect 9). Without wishing to be bound by a particular theory, the present inventors believe that the greater stability of the anode electrodes of the embodiments of the present invention under conditions of very high fuel utilization can be primarily attributed to the presence of the ceria rich interface at the three phase boundary. The mixed ionic and electronic conducting nature of the doped ceria acts as a buffer to the oxygen ion flux through the electrolyte, thus mitigating the rapid conversion of nickel to nickel oxide. Mechanical damage of the electrode/electrolyte is avoided and upon the establishment of normal operating conditions, minimal polarization change in the anode is observed. Thus, the presence of a nickel-free sublayer 13 prevents delamination of the anode under conditions of high fuel utilization, where normally the nickel at the three phase boundary would oxidize and break the sintering necks joining the electrode to the electrolyte.

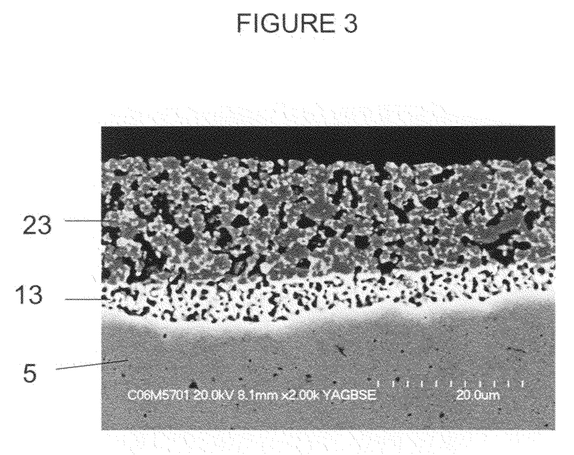

FIG. 3 illustrates a scanning electron micrograph of an exemplary fuel cell after sintering but before the reduction of the nickel oxide to nickel. The micrograph was taken with back scattered electron contrast that clearly delineates the electrolyte 5, the ceria-rich sublayer 13 (20 molar percent samaria doped ceria (SDC) Ce_{0.8}Sm_{0.2}O_{2-δ}) and the nickel rich sublayer 23 (75 wt. % nickel oxide, 25 wt % GDC/SCSZ in a 5:1 weight ratio, where the SCSZ comprises 1 molar percent ceria and 10 molar percent scandia and where the GDC is Ce_{0.6}Gd_{0.4}O_{2-δ}).

A performance of an exemplary ten cell SOFC stack was tested. Each cell comprise the same composition as above, except that the NiO was subsequently reduced to nickel. The cathode electrodes comprise LSM.

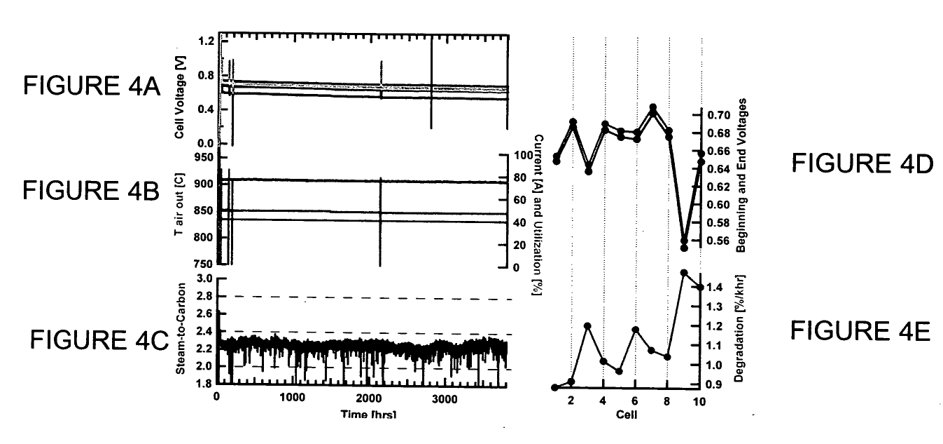

FIG. 4A is a plot of cell voltage (in volts) versus time (in hours) for the ten cells of the stack. The stack was operated at a temperature of 850° C. with a steam to carbon ratio of 2.2:1, fuel utilization of 75%, air utilization of 25% and a 40A current. FIG. 4B shows plot of the 850° C. air exhaust temperature (left axis and middle line), 40A cell current (right axis and lower line) and 75% fuel utilization (right axis and upper line) versus time. FIG. 4C is a plot of the 2.2:1 steam to carbon ratio in the fuel inlet stream versus time. The fuel comprised natural gas reformed in an external reformer.

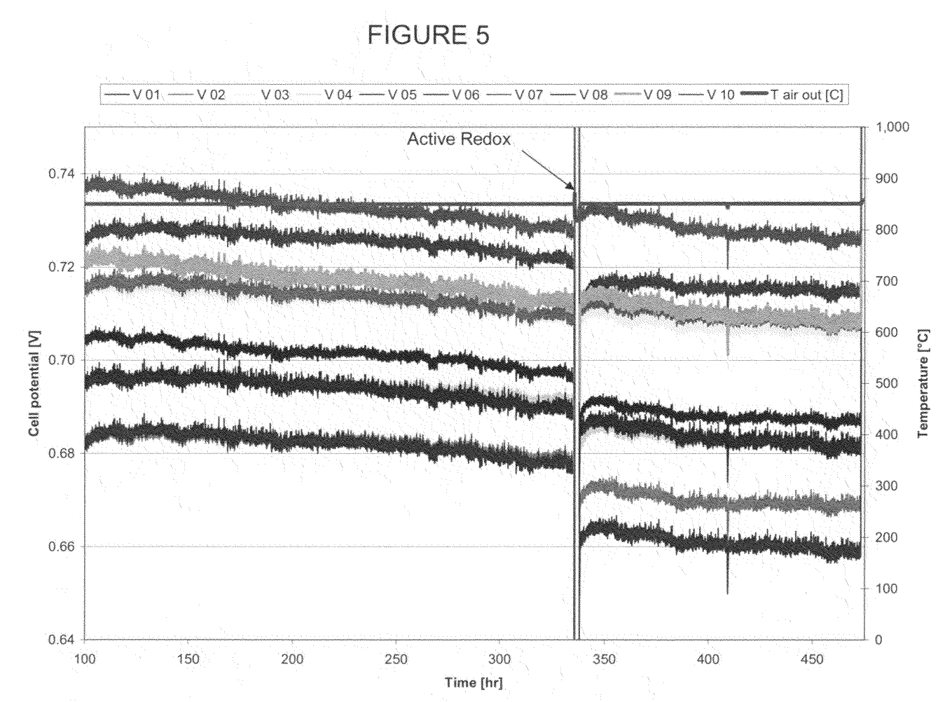

The stack was subjected to an active redox (i.e., fuel starvation) cycle for two minutes during which the fuel was turned off while drawing 40A current from the stack. FIG. 5 illustrates the performance of the ten cell stack before and after the redox cycle which occurred between 300 and 350 hours of operation. The straight line in FIG. 5 shows the 850° C. temperature of the stack air exhaust during the test. The wavy lines labeled V01 to V10 show the cell voltage (in volts) as a function of time for each of the ten cells of the stack.

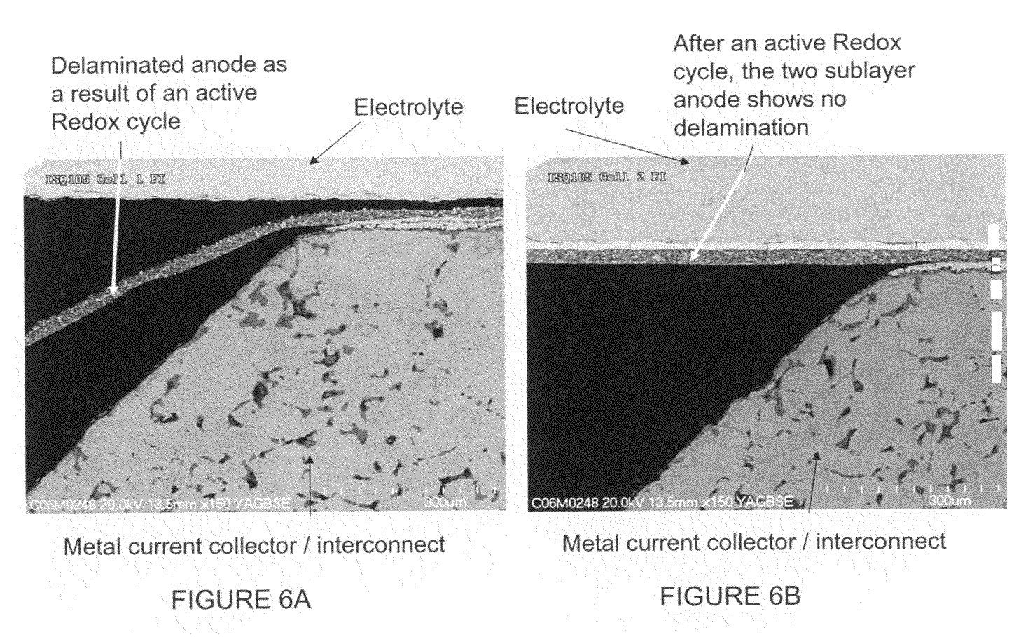

FIG. 4D is a plot of beginning voltage (upper line) and end voltage (lower line) for each of the ten tested cells according the specific example of the invention. FIG. 4E is a plot of voltage degradation for each of the ten tested cells. As can be seen from FIGS. 4D and 4E, the voltage degradation for each cell was less than 2 percent per khr for operation of the cells from 2794.78 to 3793.41 hours. Specifically, the voltage degradation was 1.5%/khr or less for all cells, and was less than 1%/khr for some of the cells. The average degradation was 1.11%/khr, while the average ASR degradation was 12.44 mOhm-cm²/khr. It is expected that the average voltage degradation would be 1%/khr or lower for a stack operated at a lower temperature, such as 800° C. In contrast, single layer anodes exhibit a voltage degradation rate of about 4%/khr at 850° C. FIG. 6A is an SEM micrograph of a single layer anode cell according to a comparative example. As can be seen from FIG. 6A, the single layer anode delaminated from the electrolyte after the redox cycle. Part of the anode shown in FIG. 6A is pressed against a rib of an interconnect/current collector of the stack, which is holding the anode in place. In contrast, FIG. 6B shows an SEM micrograph of a two sublayer anode cell according to a specific example of the invention. As can be seen from FIG. 6B, the single layer anode did not delaminate from the electrolyte after the redox cycle.

The absence of irreversible damage to the anodes of the embodiments of the invention after having suffered conditions of excessively high fuel utilization (in excess of 100%) show the fuel starvation tolerance of these anode compositions. Since events of high fuel utilization will systematically occur within the lifetime of a fuel cell system, the use of these anodes will increase reliability and lifetime of SOFC stacks.

The foregoing description of the invention has been presented for purposes of illustration and description. It is not intended to be exhaustive or to limit the invention to the precise form disclosed, and modifications and variations are possible in light of the above teachings or may be acquired from practice of the invention. The description was chosen in order to explain the principles of the invention and its practical application. It is intended that the scope of the invention be defined by the claims appended hereto, and their equivalents.

1. A solid oxide fuel cell (SOFC), comprising:
a cathode electrode;
a solid oxide electrolyte; and
an anode electrode comprising a first sublayer and a second sublayer, such that the first sublayer is located between the electrolyte and the second sublayer;
wherein:
the first sublayer comprises a doped ceria; and
the second sublayer comprises a nickel containing phase and a ceramic phase comprising a doped ceria and scandia stabilized zirconia.

2. The SOFC of claim 1, wherein the scandia stabilized zirconia comprises a scandia ceria stabilized zirconia.

3. The SOFC of claim 2, wherein the scandia ceria stabilized zirconia comprises up to 1 molar percent ceria, about 6 to about 11 molar percent scandia and a balance comprising zirconia.

4. The SOFC of claim 2, wherein a weight ratio of the doped ceria to the scandia ceria stabilized zirconia in the second sublayer ranges from about 2:1 to about 5:1.

5. The SOFC of claim 1, wherein the scandia stabilized zirconia comprises [(ZrO₂)_{1-y}(CeO₂)_{y}]₁₋ₓ(SC₂O₃)ₓ, where 0.06≦x≦0.11 and 0≦y≦0.01.

6. The SOFC of claim 1, wherein the second sublayer comprises 60 to 80 weight percent of the nickel containing phase and 40 to 20 weight percent of the ceramic phase.

7. The SOFC of claim 6, wherein the nickel containing phase consists essentially of nickel, a nickel-copper alloy, a nickel-cobalt alloy or oxides thereof.

8. The SOFC of claim 7, wherein the second sublayer comprises about 75 weight percent of the nickel containing phase and about 25 weight percent of the ceramic phase.

9. The SOFC of claim 1, wherein the doped ceria in the first sublayer comprises a trivalent oxide doped ceria and the doped ceria in the second sublayer comprises a trivalent oxide doped ceria having a same or different composition from the doped ceria in the first sublayer.

10. The SOFC of claim 9, wherein:
the trivalent oxide in the first sublayer is selected from one or more of lanthanum oxide, samarium oxide, gadolinium oxide, praseodymium oxide or yttrium oxide and the trivalent oxide comprises 10 to 40 molar percent of the doped ceria;
the trivalent oxide in the second sublayer is selected from one or more of lanthanum oxide, samarium oxide, gadolinium oxide, praseodymium oxide or yttrium oxide and the trivalent oxide comprises 10 to 40 molar percent of the doped ceria.

11. The SOFC of claim 10, wherein the doped ceria in the second sublayer comprises gadolinium oxide doped ceria.

12. The SOFC of claim 10, wherein the first sublayer consists essentially of Sm_{z}Ce_{1-z}O_{2-δ}, where 0.15≦z≦0.25.

13. The SOFC of claim 1, wherein the first sublayer does not contain nickel.

14. The SOFC of claim 1, wherein the electrolyte comprises scandia stabilized zirconia or scandia ceria stabilized zirconia.

15. The SOFC of claim 14, wherein the electrolyte comprises [(ZrO₂)_{1-y}(CeO₂)_{y}]₁₋ₓ(Sc₂O₃)ₓ, where 0.06≦x≦0.11 and 0≦y≦0.01.

16. The SOFC of claim 1, wherein electrolyte comprises a mixture of yttria stabilized zirconia and one of scandia stabilized zirconia or scandia ceria stabilized zirconia.

17. The SOFC of claim 1, wherein the first sublayer is in contact with the electrolyte and the second sublayer is located on the first sublayer.

18. The SOFC of claim 1, wherein:
the first sublayer is about 5 to about 10 microns thick;
the second sublayer is about 15 to about 30 microns thick; and
the electrolyte is about 150 to about 300 microns thick.

19. A solid oxide fuel cell (SOFC), comprising:
a cathode electrode;
a solid oxide electrolyte comprising scandia ceria stabilized zirconia which comprises up to 1 molar percent ceria, about 6 to about 11 molar percent scandia and a balance comprising zirconia; and
an anode electrode comprising a first sublayer and a second sublayer, such that the first sublayer is located between the electrolyte and the second sublayer;
wherein:
the first sublayer comprises trivalent oxide doped ceria comprising 10 to 40 molar percent of one or more trivalent oxides and a balance comprising ceria;
the second sublayer comprises a nickel containing phase and a ceramic phase comprising a doped ceria and scandia ceria stabilized zirconia;
the scandia ceria stabilized zirconia of the second sublayer comprises up to 1 molar percent ceria, about 6 to about 11 molar percent scandia and a balance comprising zirconia;
the doped ceria of the second sublayer comprises a trivalent oxide doped ceria comprising 10 to 40 molar percent of one or more trivalent oxides and a balance comprising ceria;
the second sublayer comprises 60 to 80 weight percent of the nickel containing phase and 40 to 20 weight percent of the ceramic phase; and
a weight ratio of the doped ceria to the scandia ceria stabilized zirconia in the second sublayer ranges from about 2:1 to about 5:1.

20. The SOFC of claim 19, wherein:
the trivalent oxide in the first sublayer is selected from one or more of lanthanum oxide, samarium oxide, gadolinium oxide, praseodymium oxide or yttrium oxide; and
the trivalent oxide in the second sublayer is selected from one or more of lanthanum oxide, samarium oxide, gadolinium oxide, praseodymium oxide or yttrium oxide.

21. The SOFC of claim 20, wherein:
the first sublayer consists essentially of the samaria doped ceria comprising Sm_{z}Ce_{1-z}O_{2-δ}, where 0.15≦z≦0.25;
the first sublayer does not contain nickel;
the trivalent oxide in the second sublayer consists essentially of GdₘCe₁₋ₘO_{2-δ}, where 0.1≦m≦0.4;
the nickel containing phase of the second sublayer consists essentially of either nickel or nickel oxide;
the first sublayer is in contact with the electrolyte and the second sublayer is located on the first sublayer;
the first sublayer is about 5 to about 10 microns thick;
the second sublayer is about 15 to about 30 microns thick; and
the electrolyte is about 150 to about 300 microns thick.

22. The SOFC of claim 21, wherein:
the first sublayer consists essentially of the samaria doped ceria comprising 20 molar percent samaria and a balance comprising ceria;
the second sublayer comprises about 75 weight percent of the nickel containing phase and about 25 weight percent of the ceramic phase;
the scandia ceria stabilized zirconia of the second sublayer comprises about 1 molar percent ceria, about 10 molar percent scandia and a balance comprising zirconia;
a weight ratio of the gadolinia doped ceria to the scandia ceria stabilized zirconia in the second sublayer is about 5:1.

23. A method of making a solid oxide fuel cell, comprising:
(a) providing the solid oxide fuel cell comprising:
a cathode electrode;
a solid oxide electrolyte; and
an anode electrode comprising a first sublayer and a second sublayer, such that the first sublayer is located between the electrolyte and the second sublayer;
wherein:
the first sublayer comprises a doped ceria; and
the second sublayer comprises nickel oxide and a ceramic phase comprising a doped ceria and scandia stabilized zirconia; and
(b) annealing the anode electrode in a reducing atmosphere to convert the nickel oxide to nickel.
